(19) United States
(12) Patent Application Publication
(10) Pub. No.: US 2017/0231457 A1
(43) Pub. Date: Aug. 17, 2017

(54) WATER CONTAINMENT UNIT AND FILTRATION SYSTEM

(71) Applicant: Jeremy Michael Cloud, Lufkin, TX (US)

(72) Inventor: Jeremy Michael Cloud, Lufkin, TX (US)

(21) Appl. No.: 15/435,945

(22) Filed: Feb. 17, 2017

Related U.S. Application Data
(63) Continuation-in-part of application No. 62/296,505, filed on Feb. 17, 2016.

(51) Int. Cl. A47L 13/58; B01D 21/24; B01D 35/26; C02F 1/00; B01D 29/56

(52) U.S. Cl. CPC A47L 13/58; C02F 1/001; B01D 29/56; B01D 35/26; B01D 21/2444; B01D 21/2488; C02F 2103/002

(57) ABSTRACT

A main housing provides a first reservoir and a second reservoir. Water flows from the first reservoir to the second reservoir. A draining aperture in the first reservoir directs water from the first reservoir to the second reservoir. The water may be flushed from the first reservoir to the second reservoir. In another embodiment, the water may flow directly from the first tank to the second tank without the flush. A pump circulates water from the second reservoir to the first reservoir. The pump directs the water through a filtration system to filter the water to remove at least some of the dirt, debris, and other contaminants from the water. The filtered water is then returned to the first reservoir. An overflow relief in a dividing wall of the first reservoir directs overflow water to the second reservoir.

### CROSS-REFERENCE TO RELATED APPLICATIONS

This application claims priority to and is a continuation in part of U.S. patent application Ser. No. 62/296,505 filed on Feb. 17, 2016 entitled “WATER CONTAINMENT UNIT AND FILTRATION SYSTEM.”

### STATEMENT REGARDING FEDERALLY SPONSORED RESEARCH OR DEVELOPMENT

Not Applicable.

### REFERENCE TO A MICROFICHE APPENDIX

Not Applicable.

### RESERVATION OF RIGHTS

A portion of the disclosure of this patent document contains material which is subject to intellectual property rights such as but not limited to copyright, trademark, and/or trade dress protection. The owner has no objection to the facsimile reproduction by anyone of the patent document or the patent disclosure as it appears in the Patent and Trademark Office patent files or records but otherwise reserves all rights whatsoever.

### BACKGROUND OF THE INVENTION

I. Field of the Invention

The present invention is related to a water containment system and method of operation. More specifically, the present invention is related to a water containment unit with a filtration system for filtering liquid circulated throughout the water containment unit.

Mopping a floor traditionally requires a bucket and a mop. As the user mops the floor, dirt, debris, and other contaminants collect within the bucket to dirty and/or other contaminate the water. The user then continues to clean the floor with this dirty, contaminated water. The increased amount of dirt, trash, and other debris decreases the effectiveness of mopping the floor. Microorganisms may also be introduced into the bucket each time the mop is rinsed in the bucket. The user then spreads these microorganisms across the floor by continuing to use the dirty, contaminated water.

The user must then empty, clean, and refill the bucket to continue cleaning the floor to avoid continuing to clean the floor with the dirty, contaminated water. Refilling the water in the bucket reduces the efficiency of the user. The user must spend time refilling the bucket. This time could be effectively used for cleaning the floor. Furthermore, refilling the water in the bucket increases water usage.

The user must find a place to dispose of the dirty water. The user may expose this dirty water to the environment when dumping or otherwise removing the water from the bucket. The user must then add additional water to the bucket to refill the bucket, thus increasing water usage.

II. Known Art

Patents and patent applications disclosing relevant information are disclosed below. These patents and patent applications are hereby expressly incorporated by reference in their entirety.

U.S. Publication No. 20050076465 to Rousey on Apr. 14, 2015 (“the '465 publication”) teaches a floor cleaning solution filtering system that includes a mop bucket defining a cleaning solution basin. A pump taught by the '465 publication is exteriorly mounted on the bucket and is in fluid communication with the cleaning solution basin. A filter system taught by the '465 publication is exteriorly mounted on the bucket, in fluid communication with the cleaning solution basin, and operationally connected to the pump. The pump taught by the '465 publication draws fluid from the cleaning solution basin through the filter system for return to the basin after the cleaning solution has been filtered. The bucket taught by the '465 publication may include a single basin or a dual basin.

U.S. Publication No. 20110203613 to Roberts on Aug. 25, 2011 (“the '613 publication”) teaches a mop bucket with an integrated water filtration system. A manual or electric pump taught by the '613 publication may be utilized to circulate water from the bucket through the filtration system. The pump taught by the '613 publication may also be utilized to provide water pressure to nozzles that emit streams of water for rinsing the mop head. The filtration system taught by the '613 publication may include one or more filters capable of removing particles and microbes from the water. A germ-killing light taught by the '613 publication, such as an ultraviolet light, may be incorporated into the filtration system to kill any microbes in the water. The mop bucket taught by the '613 publication may be mounted to a wheeled cart to facilitate movement. A re-chargeable battery taught by the '613 publication may be used to provide power to the pump and the germ-killing light.

### SUMMARY OF THE INVENTION

A main housing provides a first reservoir and a second reservoir. The user places the mop into the first reservoir for the cleaner water for mopping the floors. Water flows from the first reservoir to the second reservoir. A draining aperture in the first reservoir directs water from the first reservoir to the second reservoir. The water may be flushed from the first reservoir to the second reservoir. In another embodiment, the water may flow directly from the first reservoir to the second reservoir without the flush.

The dirtier water remains within the second reservoir. A pump circulates water from the second reservoir to the first reservoir. A pump intake takes in water from the second reservoir. The pump directs the water through a filtration system to filter the water to remove at least some of the dirt, debris, and other contaminants from the water. The filtered water is then returned to the first reservoir.

Outlets direct the filtered water from the second reservoir into the first reservoir. The first reservoir continues to collect the water as the pump directs the water from the second reservoir to the first reservoir. A divider wall separates the first reservoir from the second reservoir. The divider wall provides a recess that allows overflow from the first reservoir to flow into the second reservoir. Such a recess prevents the first reservoir from overflowing into the floor.

Another embodiment provides a trapping conduit that enables water to flow from the first reservoir to the second reservoir. The trapping conduit provides two vertical pathways, a downward path from the first reservoir and an upward path that leads to the second reservoir. Any sediment, sand, or other sinking debris flows downward into the trapping conduit. The upward path reduces the amount of such sediment, sand, and other sinking debris that flows from the first reservoir to the second reservoir. The user can then open the trapping conduit to remove the sediment, sand, and other sinking debris.

It is an object of the present invention to provide a versatile water filtration system.

It is another object of the present invention to provide a filter system that provides a user with cleaner water.

It is another object of the present invention to reduce water usage.

It is another object of the present invention to increase efficiency of cleaning floors.

It is another object of the present invention to reduce time spent emptying and refilling a mop bucket.

It is another object of the present invention to provide cleaner water for mopping floors.

It is another object of the present invention to promote the usage of cleaner water to mop floors.

It is another object of the present invention to remove sinking debris and floating debris from a cleaner reservoir for use during mopping.

It is another object of the present invention to provide a rolling attachment to simplify movement of the floor machine.

These and other objects and advantages of the present invention, along with features of novelty appurtenant thereto, will appear or become apparent by reviewing the following detailed description of the invention.

### BRIEF DESCRIPTION OF THE DRAWINGS

In the following drawings, which form a part of the specification and which are to be construed in conjunction therewith, and in which like reference numerals have been employed throughout wherever possible to indicate like parts in the various views:

FIG. 1 is a sectional view of one embodiment of the present invention;

FIG. 2 is a sectional view thereof;

FIG. 3 is a sectional view thereof;

FIG. 4 is a sectional view of one embodiment of the present invention;

FIG. 5 is a flow chart of one embodiment of the present invention;

FIG. 6 is a flow chart of one embodiment of the present invention;

FIG. 7 is a schematic view of a filtration system with pump of one embodiment of the present invention.

### DETAILED DESCRIPTION

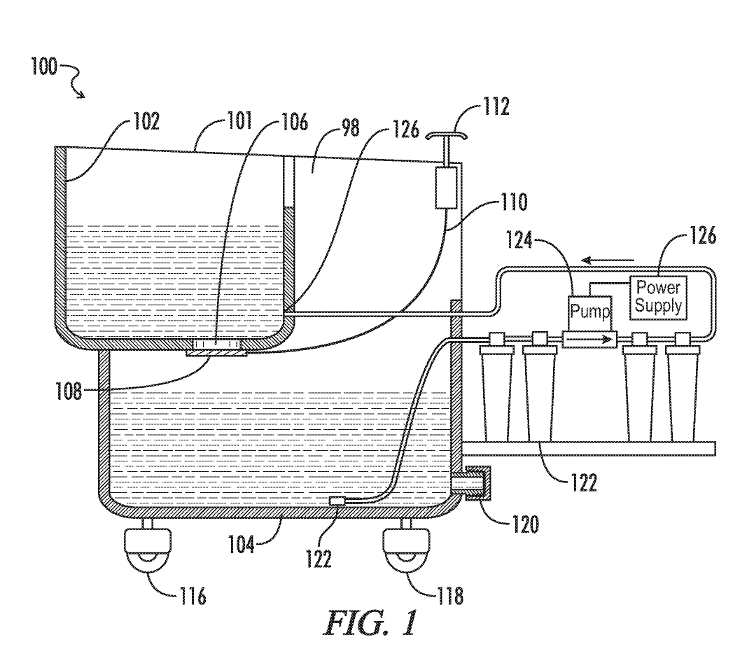

FIG. 1 shows a sectional view of a water containment unit with filtration system generally shown as 100. The water containment unit 100 provides a housing 101 supported by wheels 116, 118. In one embodiment, the water containment unit serves as a mopping system that filters water to provide user with cleaner water for mopping the floors. Wheels 116, 118 increase the mobility of the housing 101 to simplify the process of cleaning floors.

The housing 101 provides a first reservoir 102 and a second reservoir 104. The first reservoir 102 provides the cleaning water source to be applied to the floor. A wringer (not shown) may attach to the housing at opening 98 to wring the used water into the second reservoir 104. The second reservoir 104 stores the water to be filtered and circulated to the first reservoir 102.

Such recirculation of the water between the first reservoir 102 and second reservoir 104 decreases water usage. The filtering of the water increases the user's ability to continue using the same water without requiring dumping and refilling of the water.

The housing 101 may store water to clean the floors. A cleaning solution may also be stored within housing 101. A dispenser may also attach to the housing to dispense a cleaning solution into either the first reservoir, second reservoir, or both. In another embodiment, the dispenser may release a fluid that causes the debris and other contaminants to clump together for easy removal from the unit.

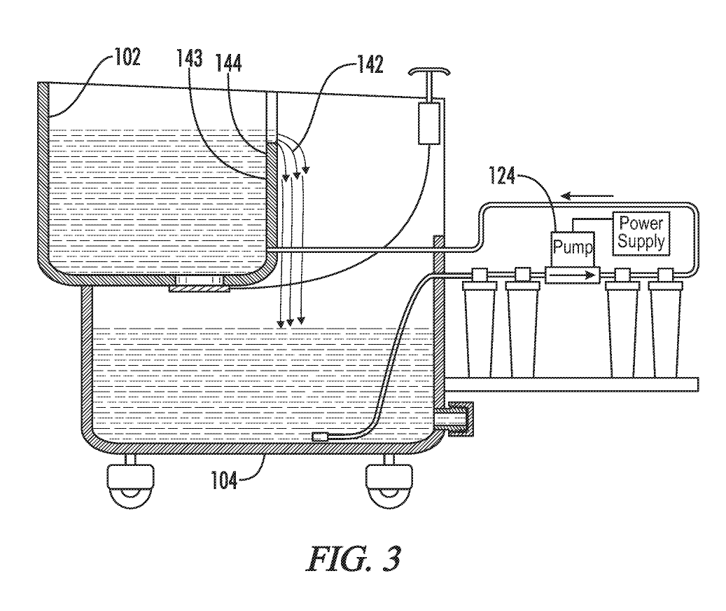

The housing 101 enables water to circulate from the first reservoir 102 to the second reservoir 104. The water from the first reservoir 102 travels to the second reservoir 104. The water may flow through a draining aperture 106 to the second reservoir 104. The water may also travel across a recess in the divider wall 143, such as the overflow relief 144 as shown in FIG. 3.

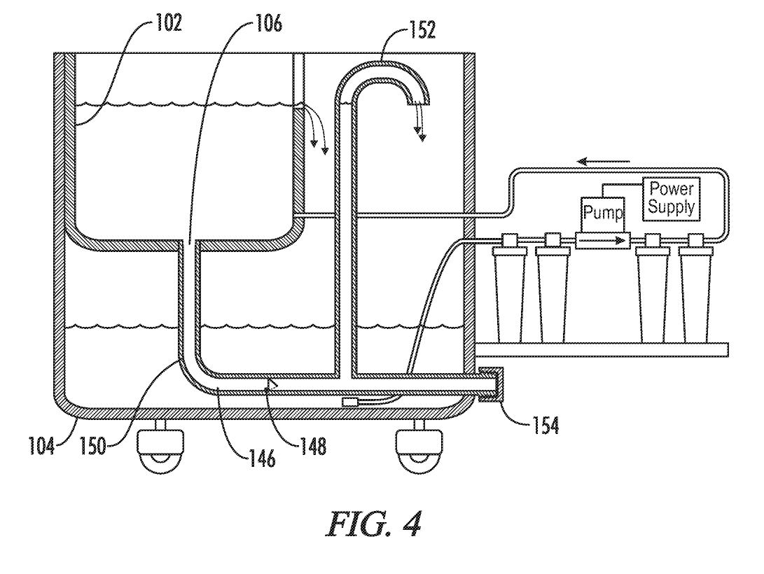

As indicated above, the first reservoir 102 serves as the cleaning source for the user. The second reservoir 104 serves as the waste water storage. As the water within the first reservoir 102 becomes dirty and/or contaminated, the user may flush the contents of the first reservoir 102 into the second reservoir 104. In another embodiment, the contents of the first reservoir 102 automatically flow to the second reservoir 104 as shown in FIG. 4.

Releasing water from the first reservoir 102 into the second reservoir 104 provides a cleaner source for cleaning the floors. The first reservoir 102 separates the cleaning source from the waste water stored within the second reservoir 104.

The unit 100 also allows water from the second reservoir 104 to flow to the first reservoir 102. A pump 124 takes in water from the second reservoir 104 at pump intake 122. The pump 124 directs the water from the second reservoir 104 through a filtration system 122. The filtration system 122 may be located before the pump 124, after the pump 124, or both before and after the pump 124. The pump 124 directs the water through the filtration system to filter the water.

The filtration system removes contaminants from the water. The filtration system 122 reduces the contaminants and debris within the water. The pump 124 then directs the water to the first reservoir 102 through outlet 126.

The pump 124 must be powered to operate. The pump may be an electric pump or a gas powered pump. The pump 124 connects to a power source 126. The power source 126 may be a battery source or a power plug to be plugged into the wall. The system may also plug into the wall to charge the battery during use.

The housing 101 also provides a drain outlet 120. The drain outlet 120 enables the user to drain water from the housing 101. Because the water flows to the second reservoir 104, the drain is located in the second reservoir 104. The drain could also be located in the first reservoir 102. In such an embodiment, the user could filter the water before draining the system.

Continuing to refer to FIG. 1, the water from the first reservoir 102 flushes into the second reservoir 104. The flushing body 108 seals or at least partially seals the draining aperture 106. The flushing body 108 may include, but is not limited to, an actuated gate valve, a flush valve, a toilet valve, or other valves. The flushing handle 112 connects to a flushing arm 110 that adjusts the flushing body 108 between the open position and the closed position.

The user adjusts the flushing handle 112 to open or close the flushing body 108. When open, the flushing body 108 releases water from the first reservoir 102 into the second reservoir. The flushing body 108 closes to reduce the water flowing from first reservoir 102 into the second reservoir 104 as shown in FIG. 1.

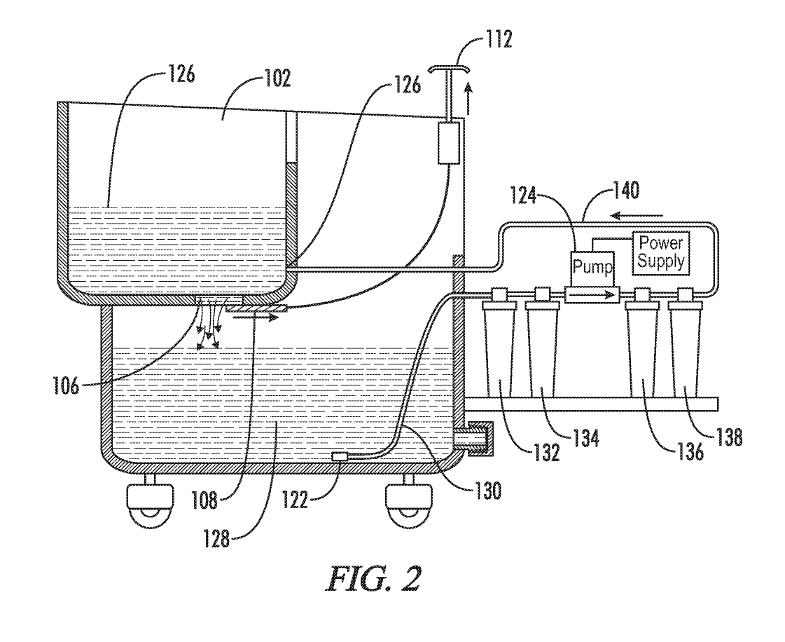

FIG. 2 shows the flushing of cleaning source water 126 from first reservoir 102 into the second reservoir 104. The second reservoir 104 stores the waste water 128. The user adjusts flushing handle 112 to open the flushing body 108. The flushing body 108 in the open position releases water from the first reservoir 102 through draining aperture 106 into the second reservoir 104.

The pump 124 takes in water through pump intake 122. The water flows from intake 122 through intake conduit 130 to the pump. Prior to reaching the pump 124, the water flows through filters 132, 134. Such a system filters the water prior to reaching the pump. These filters may range from 0.2 microns to 1000 microns.

The pump then directs the water through outlet conduit 140 to outlet 140. Prior to dispensing the filtered water into the first reservoir 102 via outlet 126, the water travels through filters 136, 138. These filters may also range from 0.2 microns to 1000 microns.

FIG. 3 shows the overflow capabilities of the present invention. To provide the user with the cleanest water source available from the water within the housing 101, the system continuously pumps and filters water from the second reservoir 104 to the first reservoir 102. Such an embodiment continuously pumps during use. Continuously pumping water into the first reservoir 102 could cause potential problems with water overflowing from the first reservoir 102. The continuous pumping could also cause too little water available for pump 124 such that the motor burns up.

To avoid these problems, the system provides a dividing wall with overflow relief 144. This overflow relief 144 provides a recess that is lower than the other walls of the first reservoir 102. The recess allows water to flow from the first reservoir to the second reservoir when the water level reaches the recess.

Overflow water 142 flows over overflow relief 144 at dividing wall when the water level reaches above the height of the recess found in dividing wall at overflow relief 144. Overflow water 142 flows into the second reservoir 104.

Enabling water to flow across the overflow relief 144 of dividing wall allows the system to remove floating debris/trash. The floating debris will not reach the filter due to the buoyance of the floating the debris. The overflow relief 144 of dividing wall allows the floating debris to float over the dividing wall into the second reservoir 104. Removing the floating debris from the first reservoir 102 reduces the possibility of the user accidentally placing the debris back on the clean floor.

FIG. 4 shows another embodiment of the present invention in which the water freely flows from first reservoir 102 to second reservoir 104. Trapping conduit 146 directs water from the first reservoir 102 to the second reservoir 104. The trapping conduit 146 provides a downward path 150 and an upward path 152. The water can flow downwards and upwards through the trapping conduit 146.

However, sand, sediment, and other sinking debris will not flow as easily across the upward pathway 152. The upward pathway 152 reduces the amount of heavier contaminants entering the second reservoir 104. The heavier contaminants flow down draining aperture 106 into the trapping conduit 146. One way valve 148 allows the water and contaminants to flow past the valve. However, the valve does not allow water to return through the valve 148.

Trap drain 154 allows the user to empty the contents of the trapping conduit 146. The user opens the trap drain 154 to empty the first reservoir 102 and the contaminants within the trapping conduit 146.

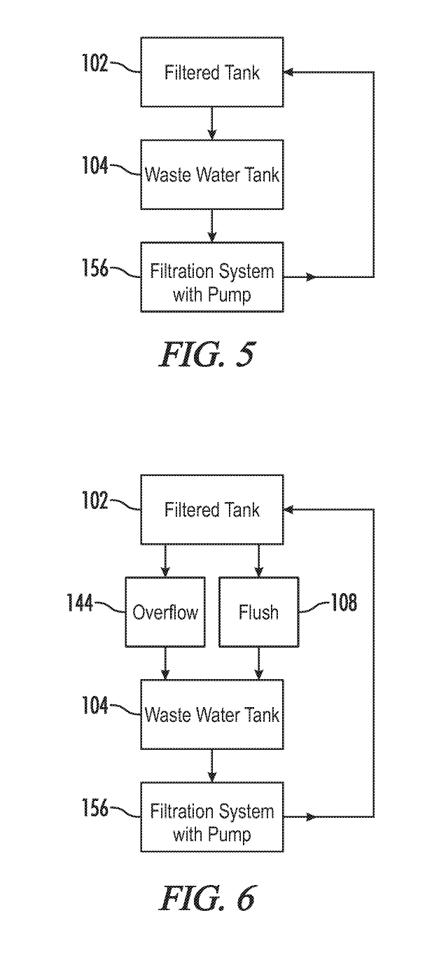

FIGS. 5 and 6 show different embodiments showing the flow of the water through the system. The water flows from the filtered tank into a waste water tank. A pump then returns the water from the waste water tank to the filtered tank. In the process of returning the water, the system filters the water through a filtration system before dispensing the filtered water into the filtered tank.

A filtered tank, such as the first reservoir 102, allows water to flow to the waste water tank, such as the second reservoir 104. This water may be flushed into the waste water tank. The water may also freely flow into the waste water tank. The water may also overflow from the filtered tank into the waste water tank across overflow relief 144 of divider wall.

A filtration system 156 with pump circulates the water from the waste water tank to the filtered tank. The filtration system filters the water from the waste water tank prior to returning the filtered water to the filtered tank.

The filtration system is constructed from either a single filter or multiple filters. The filtration system may be placed before the pump, after the pump, or both before the pump and after the pump.

FIG. 6 provides additional information concerning a flushing system. The flushing system provides continuous filtering and pumping of the water from the waste water tank to the filtered tank. The user can then flush the cleaning source from the filtered tank via flushing body 108. To prevent overflow of the filtered tank due to the continuous pumping of filtered water into the filtered tank, the filtered tank provides an overflow release, such as the recess at the overflow relief 144 of the divider wall, for the overflow water to flow from the filtered tank to the waste water tank.

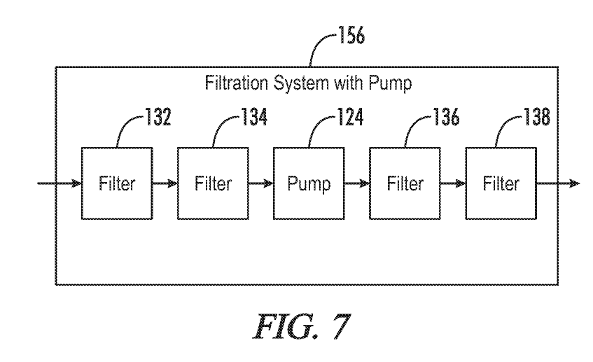

FIG. 7 shows the filtration system 156 with pump. The filtration system, as discussed above, can be placed in the path of the water as it is pumped to the pump. The filtration system can also be placed in the path of the water as it is pumped from the pump to the outlet for releasing the filtered water into the filtered tank. In another embodiment, two separate filtration systems are implemented in the system. One filtration system is located in the path of the water from the waste water tank to the pump. The second filtration system is located in the path of the water from the pump to the filtered tank.

FIG. 7 shows a filtration system in which the filters occur in the path both prior to the pump 124 and after the pump 124. Such a filtration system 156 provides filters 132, 134 prior to the water reaching the pump. The filtration system 156 also provides filters 136, 138 as the water travels from the pump 125 to the filtered tank. The pump 124 directs the water through filters 132, 134, 136, 138 as the water travels from the waste water tank to the filtered tank.

FIG. 7 shows a multistage filtration system in which the water is filtered twice through filters 132, 134 prior to reaching the pump. The water is filtered twice through filters 136, 138 after the pump. These filters 132, 134 prior to the pump 124 range from 0.2 microns to 1000 microns, preferably 25 microns to 200 microns. These filters 136, 138 after pump 124 range from 0.2 microns to 1000 microns, preferably 0.2 microns to 25 microns.

Other filtration systems can be implemented in the present invention. In one embodiment, a single filter provides multiple different stages within the single filter. The different layers of the single filter provide different sized filtering of the water. The single filter filters the water from the waste water tank to the filtered tank. The single filter may be placed before the pump or after the pump. In one embodiment, the single filter provides different layers that filter at different microns at each level. Such layers may range from 0.2 microns to 1000 microns.

These filter(s) may be removable from the system to be replaced. In some embodiments, the user may wash the filters and reuse the cleaned filters. The filtration system provides a convenient method of removing and replacing the filters within the filtration system.

The present invention may also provide a mesh screen to remove debris from the first reservoir and the second reservoir. The mesh screen may be placed within a filter housing of the present invention. The mesh screen could also be installed with the second reservoir for filtering contaminants from the water.

The system may also implement ultraviolet light or other light to kill bacteria, clean, or otherwise treat the water. The system may also implement an ionization technique within the water to kill bacteria, clean, or otherwise treat the water. The system may also provide a dispenser that dispenses cleaning solution or other substance that may assist with collecting debris or otherwise cleaning the water.

Another embodiment of the present invention may provide alternative filters, such as specialty filters. Such filters may include oil filters, grease filters, etc. Such a filter may include an organoclay filter that removes oils, grease, and other substance from the water. The different types of filters may be implemented based upon the environment in which the system is used.

Another embodiment of the present invention may provide a first reservoir and second reservoir that are secured to each other. Another embodiment provides a first reservoir and second reservoir that are detachable from each other. The first reservoir and second reservoir are placed to allow the water to circulate between the first reservoir and the second reservoir.

From the foregoing, it will be seen that the present invention is one well adapted to obtain all the ends and objects herein set forth, together with other advantages which are inherent to the structure.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the accompanying drawings is to be interpreted as illustrative and not in a limiting sense.

What is claimed is:

1. A water filtration system for filtering water to remove contaminants from the water to provide a cleaner source of water, the system comprising:
a first reservoir for storing the water;
a second reservoir that receives water from the first reservoir;
a draining aperture within the first reservoir that directs the water from the first reservoir to the second reservoir;
a pump that circulates water from the second reservoir to the first reservoir;
at least one filter wherein water pumped from the second reservoir to the first reservoir passes through the filter before releasing the filtered water into the first reservoir.

2. The system of claim 1 further comprising:
a dividing wall that separates the first reservoir from the second reservoir;
an overflow relief within the dividing wall that allows water to overflow from the first reservoir to the second reservoir.

3. The system of claim 1 further comprising:
a pump intake located within the second reservoir;
an intake conduit connecting the pump intake to the pump wherein the water flows through the intake conduit from the second reservoir to the pump.

4. The system of claim 3 wherein the filter is located between the pump intake and the pump along the intake conduit to filter the water from the pump intake prior to the water reaching the pump.

5. The system of claim 4 further comprising:
a second filter located in a path of the water from the pump to the first reservoir wherein the second filter filters the water prior to the water reaching the first reservoir.

6. The system of claim 1 further comprising:
An outlet connected to the pump wherein the pump directs the filtered water through the outlet into the first reservoir;
an outlet conduit connecting the pump to the outlet wherein the water flows through the outlet conduit from the pump to the first reservoir.

7. The system of claim 6 wherein the filter is located between the pump and the outlet along the outlet conduit to filter the water from the pump prior to the water reaching the outlet.

8. The system of claim 7 further comprising:
a second filter located in a path of the water from the second reservoir to the pump wherein the second filter filters the water prior to the water reaching the pump.

9. The system of claim 1 further comprising:
a set of wheels attached to the second reservoir.

10. The system of claim 1 further comprising:
a flushing body placed at the draining aperture wherein the flushing body adjusts between a closed position that reduces water flowing through the draining aperture into the second reservoir and an open position that releases water from the first reservoir into the second reservoir.

11. The system of claim 1 further comprising:
a trapping conduit located at the draining aperture, the trapping conduit having a downward pathway and an upward pathway wherein the water flowing through the trapping conduit flows downwards before flowing upwards to reach the second reservoir.

12. The system of claim 11 further comprising:
a valve located in the flow of the water through the trapping conduit wherein the valve is located between the downward pathway and the upward pathway.

13. A water filtration system for filtering water to remove contaminants from the water to provide a cleaner source of water, the system comprising:
a first reservoir for storing the water;
a second reservoir that receives water from the first reservoir;
a draining aperture within the first reservoir that directs the water from the first reservoir to the second reservoir;
a pump that circulates water from the second reservoir to the first reservoir wherein the pump takes in water from the second reservoir and directs the water to the first reservoir;
at least one filter wherein water pumped from the second reservoir to the first reservoir passes through the filter before releasing the filtered water into the first reservoir.

14. The system of claim 13 further comprising:
a dividing wall that separates the first reservoir from the second reservoir;
an overflow relief within the dividing wall that allows water to overflow from the first reservoir to the second reservoir.

15. The system of claim 13 wherein the filter is located in the path of the water from the second reservoir to the pump wherein the filter filters the water prior to the water reaching the pump.

16. The system of claim 15 further comprising:
a second filter located in a path of the water from the pump to the first reservoir wherein the second filter filters the water prior to the water reaching the first reservoir.

17. The system of claim 13 wherein the filter is located in the path of the water from the pump to the first reservoir wherein the filter filters the water prior to the water reaching the first reservoir.

18. The system of claim 13 further comprising:
a flushing body placed at the draining aperture wherein the flushing body adjusts between a closed position that reduces water flowing through the draining aperture into the second reservoir and an open position that releases water from the first reservoir into the second reservoir.

19. The system of claim 13 further comprising:
a trapping conduit located at the draining aperture, the trapping conduit having a downward pathway and an upward pathway wherein the water flowing through the trapping conduit flows downwards before flowing upwards to reach the second reservoir; and
a valve located in the flow of the water through the trapping conduit wherein the valve is located between the downward pathway and the upward pathway.

20. A water filtration system for filtering water to remove contaminants from the water to provide a cleaner source of water, the system comprising:
a first reservoir for storing the water;
a second reservoir that receives water from the first reservoir;
a draining aperture within the first reservoir that directs the water from the first reservoir to the second reservoir;
a pump that continuously circulates water from the second reservoir to the first reservoir;
at least one filter wherein water pumped from the second reservoir to the first reservoir passes through the filter before releasing the filtered water into the first reservoir;
a dividing wall that separates the first reservoir from the second reservoir;
an overflow relief within the dividing wall that allows water to overflow from the first reservoir to the second reservoir; and
a flushing body placed at the draining aperture wherein the flushing body adjusts between a closed position that reduces water flowing through the draining aperture into the second reservoir and an open position that releases water from the first reservoir into the second reservoir.
